(19) United States
(12) Patent Application Publication
(10) Pub. No.: US 2007/0130790 A1
(43) Pub. Date: Jun. 14, 2007

(54) Clothes drying machine having a sealing member

(75) Inventor: Woo Sup Jung, Seongnam (KR)

Correspondence Address: STAAS & HALSEY LLP, SUITE 700, 1201 NEW YORK AVENUE, N.W., WASHINGTON, DC, 20005, US

(73) Assignees: Samsung Electronics Co., Ltd., Suwon-si (KR); P.K. Tech System Co., Ltd., Bucheon-si (KR)

(21) Appl. No.: 11/523,583

(22) Filed: Sep. 20, 2006

(30) Foreign Application Priority Data
Dec. 9, 2005 (KR) 10-2005-0121148

(51) Int. Cl. F26B 25/00; F26B 11/02

(52) U.S. Cl. 34/242; 34/603

(57) ABSTRACT

A clothes drying machine, which reduces the deterioration of the elastic force of a sealing member maintaining the hermetic sealing of a gap between the rear surface of a door and the front surface of a housing. The clothes drying machine includes a housing provided with an opening formed through the front surface thereof for allowing a user to put laundry into the housing; a door hinged to one side of the front surface of the housing and rotated to open and close the opening; and a sealing member installed on the rear surface of the door for preventing steam from leaking to the outside through a gap between the rear surface of the door and the front surface of the housing, wherein the sealing member comprises a sealing portion interposed between the rear surface of the door and the front surface of the housing for maintaining the sealing of the gap between the rear surface of the door and the front surface of the housing, and an elastic deforming portion having an arc-shaped cross section for allowing the sealing portion to be elastically deformed is formed on one end of the sealing portion. The clothes drying machine allows the sealing member to be elastically deformed under the condition that the elastic deforming portion is uniformly deformed, thereby preventing the deterioration of the elastic force of the sealing member caused by the accumulation of fatigue on a specific part of the sealing member.

### CROSS-REFERENCE TO RELATED APPLICATION

This application claims the benefit of Korean Patent Application No. 2005-0121148, filed Dec. 9, 2005, in the Korean Intellectual Property Office, the disclosure of which is incorporated herein by reference.

### BACKGROUND OF THE INVENTION

1. Field of the Invention

The present invention relates to a clothes drying machine, and more particularly, to a clothes drying machine, which reduces the deterioration of the elastic force of a sealing member maintaining the hermetic sealing of a gap between the rear surface of a door and the front surface of a housing.

2. Description of the Related Art

Generally, clothes drying machines dry wet laundry by supplying hot air to the laundry. A conventional clothes drying machine comprises a housing defining the external appearance of the drying machine, a drying tub installed in the housing for containing laundry, and a heater and a blast fan for supplying hot air to the drying tub. The conventional clothes drying machine dries the laundry by forcibly circulating air heated by the heater to the drying tub through the blast fan.

Korean Patent Laid-open Publication No. 2005-50904 discloses a clothes drying machine, in which an opening for allowing a user to put laundry into and take the laundry out of the drying machine is formed through the front surface of a housing and a door is hinged to one side of the front surface of the housing at a position close to the opening and rotated to open and close the opening.

A sealing member for preventing the air at a high-temperature state in the drying tub from leaking to the outside of the drying machine through a gap between the rear surface of the door and the front surface of the housing is installed on the rear surface of the door.

The sealing member has a ring shape, and contacts a portion of the front surface of the housing close to the opening. The circumferential size of the sealing member is slightly bigger than the opening and the cross-section is divided into a plurality of hollow portions. Furthermore, the sealing member is made of an elastic material and has contacting portion for contacting the front surface of the housing and a folded portion, which has an approximately V-shaped cross section for helping to provide elastic force upon the front surface of the housing when the door is closed.

As the door of the above conventional clothes drying machine is repeatedly opened and closed for a long period of time, the folded portion of the sealing member becomes deformed. Thus, the elastic force of the deformed folded portion is reduced, thereby causing a difficulty in contact between the sealing member and the front surface of the housing.

### SUMMARY OF THE INVENTION

Therefore, one aspect of the invention is to provide a clothes drying machine which reduces the deterioration of the elastic force of a sealing member even when the sealing member is used for a long period of time.

Another aspect of the invention is to provide a clothes drying machine, which prevents steam from leaking to the outside of the drying machine through a gap between the rear surface of a door and the front surface of a housing.

In accordance with one aspect, the present invention provides a clothes drying machine comprising: a housing provided with an opening formed through the front surface thereof for allowing a user to put laundry into the housing; a door hinged to one side of the front surface of the housing and rotated to open and close the opening; and a sealing member installed on the rear surface of the door for preventing steam from leaking to the outside through a gap between the rear surface of the door and the front surface of the housing, wherein the sealing member comprises a sealing portion interposed between the rear surface of the door and the front surface of the housing for maintaining the sealing of the gap between the rear surface of the door and the front surface of the housing, and an elastic deforming portion having an arc-shaped cross section for allowing the sealing portion to be elastically deformed is formed on one end of the sealing portion.

In accordance with another aspect, the present invention provides a clothes drying machine comprising: a housing provided with an opening formed through the front surface thereof for allowing a user to put laundry into the housing; a door hinged to one side of the front surface of the housing and rotated to open and close the opening; and a sealing member installed on the rear surface of the door for preventing steam from leaking to the outside through a gap between the rear surface of the door and the front surface of the housing, wherein the sealing member comprises first and second supporting portions, each having a ring shape, and supported by the front surface of the housing, and disposed in parallel in the radial direction.

### BRIEF DESCRIPTION OF THE DRAWINGS

These and/or other aspects and advantages of the invention will become apparent and more readily appreciated from the following description of the preferred embodiments, taken in conjunction with the accompanying drawings in which:

FIG. 1 is a sectional view of a clothes drying machine in accordance with the present invention; and

FIG. 2 is an enlarged view of the portion “II” of FIG. 1.

### DETAILED DESCRIPTION OF THE PREFERRED EMBODIMENTS

Reference will now be made in detail to the embodiment of the present invention, an example of which is illustrated in the accompanying drawings, wherein like reference numerals refer to like elements throughout. The embodiment is described below to explain the present invention by referring to the annexed drawings.

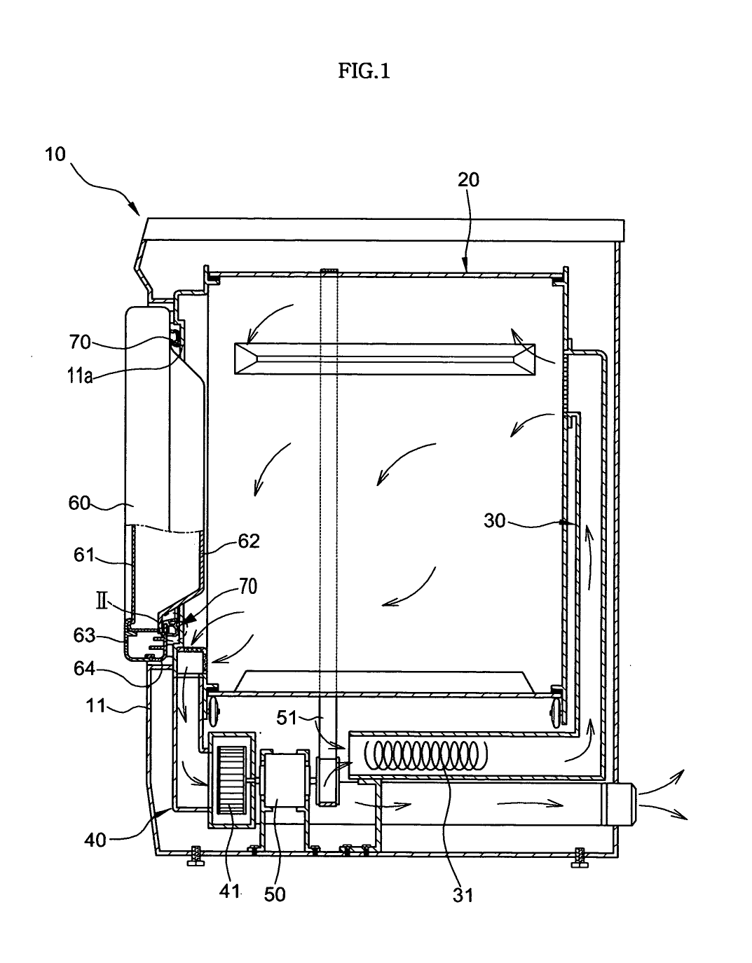

As shown in FIG. 1, a clothes drying machine in accordance with the present invention comprises a housing 10 defining the external appearance of the drying machine, and a drying tub 20 having a cylindrical shape rotatably installed in the housing 10 for containing laundry to be dried. In the clothes drying machine, hot air is supplied to the drying tub 20, and dries the laundry contained in the drying tub 20.

In order to dry the laundry, one end of a hot air suction duct 30 for supplying the hot air to the drying tub 20 is connected to the rear portion of the drying tub 20, and one end of a hot air discharge duct 40 for guiding the discharge of the hot air from the drying tub 20 after drying the laundry is connected to the front portion of the drying tub 20. A heater 31 for heating air passing through the hot air suction duct 30 to generate the hot air is installed in the hot air suction duct 30, and a blast fan 41 rotated to generate suction force and blowing force is installed in the hot air discharge duct 40. Accordingly, when the blast fan 41 is rotated to generate suction force and blowing force, the air moves along the hot air suction duct 30, the drying tub 20, and the hot air discharge duct 40. When the air is supplied to the drying tub 20 through the hot air suction duct 30, the air is heated by the heater 31 and is converted into hot air, and the hot air supplied to the drying tub 20 dries the laundry in the drying tub 20 and is then discharged from the drying tub 20 to the outside through the hot air discharge duct 40.

A driving motor 50 for generating rotary force using received power is installed below the drying tub 20. The blast fan 41 is rotated by the rotary force transmitted from one end of a rotary shaft of the driving motor 50, and the drying tub 20 is rotated by the rotary force transmitted from the other end of the rotary shaft of the driving motor 50 through a belt 51.

In the clothes drying machine of the present invention, an opening 11a for allowing a user to put laundry into or take the laundry out of the drying machine is formed through a front panel 11 forming the front surface of the housing 10, and a door 60 for opening and closing the opening 11a is hinged to one side of the front surface of the housing 10 close to the opening 11a. The door 60 is rotated, thereby opening and closing the opening 11a.

The door 60 comprises a transparent window installed at the central portion thereof and made of a transparent material for allowing a user to see the inside of the drying tub 20 therethrough, and a front frame 63 and a rear frame 64, each having a ring shape, installed at the circumference of the transparent window and interconnected so that the transparent window can be fixedly interposed between the front and rear frames 63 and 64. The transparent window has a dual structure including a front window 61 and a rear window 62 so that an air layer can be formed between the front and rear windows 61 and 62, thus exhibiting an adiabatic effect due to the air layer formed between the front and rear windows 61 and 62.

The clothes drying machine of the present invention further comprises a sealing member 70 installed on the rear surface of the door 60. The sealing member 70 contacts a portion of the front panel 11 close to the opening 11a when the opening 11a is closed by the door 60, thereby for preventing the internal air in a high-temperature state from leaking to the outside of the drying machine through a gap between the rear surface of the door 60 and the housing 10.

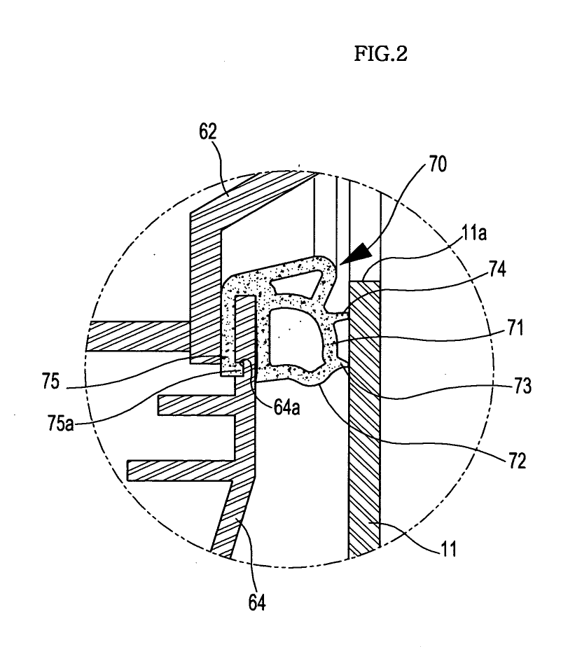

The sealing member 70 is made of a material, such as rubber or silicon or PVC such as soft PVC. As shown in FIG. 2, the sealing member 70 is elastically deformed and contacts the portion of the front panel 11 close to the opening 11a, when the door 60 is closed, thus preventing the leakage of the air. Further, the sealing member 70 has a ring shape corresponding to the shape of the portion of the front panel 11 close to the opening 11a.

The sealing member 70 comprises a sealing portion 71 disposed between the rear surface of the door 60 and the front surface of the housing 10 when the door 60 is closed for maintaining the sealing of a gap between the rear surface of the door 60 and the front surface of the housing 10.

The sealing portion 71 is hollow and is made of elastic material so that the thickness of the sealing portion 71 can be changed due to its elasticity and the sealing portion 71 can contact the front surface of the housing 10. An elastic deforming portion 72 having an arc-shaped cross section for allowing the sealing portion 71 to be elastically deformed is formed on the outer circumferential end of the sealing portion 71. The arc-shape of the elastic deforming portion is bent in the inward direction of the sealing portion 71 and becomes further bent in the inward direction when the door is closed and the front surface of the housing 10 presses upon the sealing member 70. When the elastic deforming portion 72 having an arc-shaped cross section is formed on the outside corner of the sealing portion 71, force applied to the sealing member 70 when the door 60 is closed is uniformly dispersed to the arc-shaped elastic deforming portion 72, thereby allowing the elastic deforming portion 72 to be uniformly deformed. Although the entire sealing member 70 is preferred to be made of same material, the sealing portion 71 may exhibit same, less or more elasticity than the elastic deforming portion 72. In fact, the sealing portion 71 may be made of a material that exhibits no substantial elasticity such as a hard PVC.

When the elastic deforming portion 72 is uniformly deformed, the amount of the deformation of the sealing portion 71 is maintained at more than a designated degree, and respective parts of the elastic deforming portion 72 are maintained at less than a designated degree. Thereby, fatigue accumulated at the respective parts of the elastic deforming portion 72 is relatively small. Accordingly, even when the sealing member 70 is used for a long period time, the deterioration of the elastic force of the sealing member 70 is drastically reduced.

In order to more firmly maintain the sealing of the gap between the rear surface of the door 60 and the front surface of the housing 10 by the elastic force of the elastic deforming portion 72, the sealing portion 71 comprises supporting portions 73 and 74, each having a ring shape, extended backwardly from the rear surface of the sealing portion 71 and supported by the front surface of the housing 10. Since the elastic force of the elastic deforming portion 72 is applied to the supporting portions 73 and 74, the supporting portions 73 and 74 serve to more firmly maintain the sealing of the gap between the rear surface of the door 60 and the front surface of the housing 10. In this embodiment, the supporting portions 73 and 74 include a first supporting portion 73 having a ring shape extended backwardly from the outer portion of the sealing portion 71, and a second supporting portion 74 located at the inside of the first supporting portion 73 in parallel with the first supporting portion 73. Even when the air in the drying tub 20 leaks through a gap between the second supporting portion 74 and the front surface of the housing 10, the first supporting portion 73 captures the leaking air, thereby preventing the air from leaking to the outside of the drying machine. Additionally, a third or more supporting portions can be incorporated in the sealing member 70..

The sealing member 70 is partially interposed between the rear frame 64 and the rear window 62 so that the sealing member 70 can be fixed to the rear surface of the door 60. For this reason, the sealing member 70 further comprises a fixing portion 75 interposed between the rear frame 64 and the rear window 62.

In order to more stably install the fixing portion 75 of the sealing member 70 between the rear frame 64 and the transparent window, a protrusion 75a towards the rear frame 64 is formed on the fixing portion 75, and a recess 64a, into which the protrusion 75a is inserted, is formed in the rear frame 64. Accordingly, the protrusion 75a is inserted into the recess 64a, thereby preventing the sealing member 70 from being separated from the door 60. It is noted that the sealing member 70 may be installed on the front surface of the housing without departing from the spirit of the invention. In this case, the orientation of the sealing member 70 is turned around 180 degrees and an adhesive may be used to fix it on the front surface of the housing 10.

As apparent from the above description, the present invention provides a clothes drying machine, which comprises an elastic deforming portion having an arc-shaped cross section for allowing a sealing member to be elastically formed under the condition that the elastic deforming portion is uniformly deformed, thereby preventing the deterioration of the elastic force of the sealing member caused by the accumulation of fatigue on a specific part of the sealing member.

Further, the clothes drying machine of the present invention comprises first and second supporting portions formed in parallel on the sealing member, thereby firmly maintaining the sealing of a gap between the rear surface of a door and the front surface of a housing.

Although an embodiment of the invention has been shown and described, it would be appreciated by those skilled in the art that changes may be made in this embodiment without departing from the principles and spirit of the invention, the scope of which is defined in the claims and their equivalents.

What is claimed is:

1. A clothes drying machine comprising:
a housing provided with an opening formed through the front surface thereof for allowing a user to put laundry into the housing;
a door hinged to one side of the front surface of the housing and rotated to open and close the opening; and
a sealing member installed on the rear surface of the door for preventing steam from leaking to the outside through a gap between the rear surface of the door and the front surface of the housing,
wherein the sealing member comprises a sealing portion interposed between the rear surface of the door and the front surface of the housing for maintaining the sealing of the gap between the rear surface of the door and the front surface of the housing, and an elastic deforming portion having an arc-shaped cross section for allowing the sealing portion to be elastically deformed is formed on one end of the sealing portion.

2. The clothes drying machine as set forth in claim 1, wherein the sealing member further comprises supporting portions, each having a ring shape, protruded backwardly from the sealing portion and supported by the front surface of the housing, and comprising a first supporting portion disposed at the outer portion of the sealing member and a second supporting portion disposed at the inside of the first supporting portion in parallel with the first supporting portion.

3. The clothes drying machine as set forth in claim 1, wherein:
the door comprises a transparent window for allowing the user to see the inside of the housing therethrough, and a front frame and a rear frame, each having a ring shape, forming the edge of the door and interconnected so that the transparent window can be installed therebetween; and
the sealing member further comprises a fixing portion interposed between the inner circumferential surface of the rear frame and the rear surface of the transparent window for installing the sealing member on the door.

4. A clothes drying machine comprising:
a housing provided with an opening formed through the front surface thereof for allowing a user to put laundry into the housing;
a door hinged to one side of the front surface of the housing and rotated to open and close the opening; and
a sealing member installed on the rear surface of the door for preventing steam from leaking to the outside through a gap between the rear surface of the door and the front surface of the housing,
wherein the sealing member comprises supporting portions, each having a ring shape, protruded backwardly from the sealing member and supported by the front surface of the housing, and comprising a first supporting portion and a second supporting portion disposed in parallel in the radial direction.

5. The clothes drying machine as set forth in claim 4, wherein an elastic deforming portion having an arc-shaped cross section for allowing the sealing member to be elastically deformed is formed on the outer circumferential end of the sealing member.

6. The clothes drying machine as set forth in claim 4, wherein:
the door comprises a transparent window for allowing the user to see the inside of the housing, and a front frame and a rear frame, each having a ring shape, forming the edge of the door and interconnected so that the transparent window can be installed therebetween; and
the sealing member further comprises a fixing portion interposed between the inner circumferential surface of the rear frame and the rear surface of the transparent window for installing the sealing member on the door.

7. A clothes drying machine comprising:
a housing provided with an opening formed through the front surface thereof for allowing a user to put laundry into the housing;
a door hinged to one side of the front surface of the housing and rotated to open and close the opening; and
a sealing member installed between the rear surface of the door and the front surface of the housing for preventing steam from leaking to the outside through a gap between the rear surface of the door and the front surface of the housing,
wherein the sealing member is made of an elastic material and has a first portion which has an arc-shaped cross section, said first portion being bent in the inward direction of the sealing member.

8. The clothes drying machine as set forth in the claim 7, wherein said sealing member is made entirely of a same material.

9. The clothes drying machine as set for in the claim 8, wherein said sealing member is made of a soft PVC.

10. The clothes drying machine as set for in the claim 7, wherein said first portion is further bent in the inward direction of sealing member when the door is closed.

11. The clothes drying machine as set for in the claim 7, wherein said sealing member has a second portion having a plurality of exteriorly protruding members, each shaped as a ring, for abutment against the front surface of the housing when the door is closed.

12. The clothes drying machine as set forth in the claim 11, wherein said exteriorly protruding members are substantially parallel to each other.

13. A clothes drying machine comprising:
a housing provided with an opening formed through the front surface thereof for allowing a user to put laundry into the housing;
a door hinged to one side of the front surface of the housing and rotated to open and close the opening; and
a sealing member installed between the rear surface of the door and the front surface of the housing for preventing steam from leaking to the outside through a gap between the rear surface of the door and the front surface of the housing,
wherein the sealing member is made of an elastic material and has a plurality of extruding members, formed in the shape of a ring, for abutment against the front surface of the housing.

14. The clothes drying machine as set forth in the claim 13, wherein said plurality of extruding members are parallel to each other.

15. The clothes drying machine as set forth in the claim 14, wherein said sealing member is entirely made of a same material.

16. The clothes drying machine as set forth in the claim 15, wherein said sealing member is made of a soft PVC.
